(19) United States
(12) Patent Application Publication
(10) Pub. No.: US 2016/0088090 A1
(43) Pub. Date: Mar. 24, 2016

(54) SYSTEM AND METHOD FOR SENSOR PRIORITIZATION

(71) Applicant: Intel Corporation, Santa Clara, CA (US)

(72) Inventors: Lenitra M. Durham, Beaverton, OR (US); Andrea Johnson, Beaverton, OR (US); Glen J. Anderson, Beaverton, OR (US); Kofi Whitney, Hillsboro, OR (US); Philbert Lin, Hillsboro, IL (US); Joseph A. Cianfrone, San Jose, CA (US)

(21) Appl. No.: 14/495,563

(22) Filed: Sep. 24, 2014

(51) Int. Cl. H04L 29/08; G06N 5/04

(52) U.S. Cl. CPC H04L 67/125; G06N 5/04

(57) ABSTRACT

A system and method for prioritizing data from a plurality of wearable sensor modules in a sensor system. A primary sensor module is selected as a function of operation parameters associated with operation of each of wearable sensor modules. Parameter data measured by two or more of the wearable sensor modules is combined, wherein combining includes reviewing the operation parameters of the wearable sensor modules supplying the parameter data to be combined and combining the data as a function of the reviewed operation parameters.

### BACKGROUND ART

Wearable physical activity monitoring devices are typically limited by their placement and size in their ability to provide accurate measurements. For example a wrist-based device can detect physical movement of a user moving but may not distinguish if the wearer is walking, running or riding a bike. In addition, the wearable ensemble may have redundant data from the various sensors in the system; the user often must determine which sources should be relied upon for pertinent data.

Wearable device ensembles to date tend to place sensor modules into a primary+companion device relationship or a primary+primary device relationship. In some such approaches, one device typically offers up data while the other is used to view and manipulate that data. In other approaches, both devices provide data independently and the user must make the determination of when and how to view the relevant information.

Some attempts have been made to assess data. The COSAR system is one example of multiple sensors being used across two devices to allow a system to determine user activity. The COSAR system uses accelerometer data from a phone and a wrist-based device, as well as GPS/location info, to determine user activity. COSAR attempts to accomplish this by combining context information (the user's GPS location) with accelerometer data to determine the type of activity in which the user is engaged.

Other approaches combine multiple sensors into a single system. For instance, Google has proposed a smart shoe that tracks physical activity, communicates with cell phone contacts, provides vocal encouragement and pushes information to social networks. The Google smart shoe does not, however, bring any situational awareness to physical activities being measured by its sensors.

What is needed is a system and method for combining data from multiple, disparate, sensors to arrive at a clearer picture of a user's activity.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a wearable sensor prioritization system according to one aspect of the present invention;

FIG. 2 illustrates another embodiment of a wearable sensor prioritization system;

FIG. 3 illustrates a multiple wearable activity monitoring architecture;

FIG. 4 illustrates process flow in a wearable sensor prioritization system;

FIGS. 5-7 illustrate example embodiments of sensor prioritization; and

FIG. 8 is a block diagram illustrating an example machine upon which any one or more of the techniques (e.g., methodologies) discussed herein may perform, according to an example embodiment.

### DESCRIPTION OF THE EMBODIMENTS

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

In the future, as more and more wearable devices are worn by a user, the data provided by these devices will increasingly need to be combined to arrive at a clearer picture of the user's activities and, in some cases, condition. For instance, although each device may be designed to monitor a specific sensor, the combined data from these devices can be used to provide an accurate representation of parameters such as user activity, activity level, performance, and calories burned.

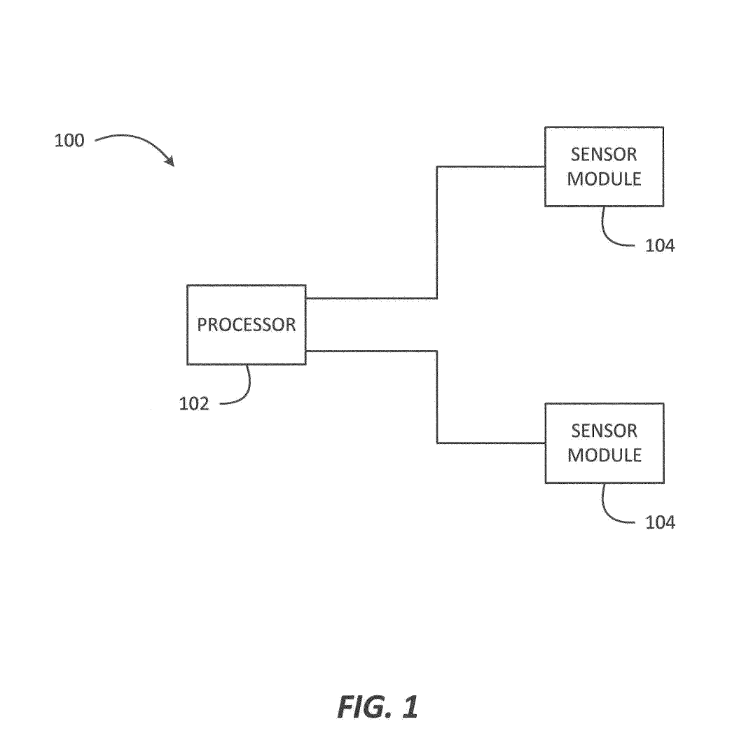

An example embodiment of a wearable sensor prioritization system is shown in FIG. 1. In the example embodiment of FIG. 1, processor 102 is connected to two or more sensor modules 104. Processor 102 receives data from sensor modules 104 and processes the data to build a coherent picture based on the data. In some embodiments, one or more of the sensor modules 104 are wearable devices.

In an embodiment, for example, processor 102 considers the placement of a particular sensor module 104 along with the user's environment to provide an accurate picture of the user activity supported with real-time quantitative metrics (such as, for example, activity level, performance and calories burned). In some such embodiments, the information that the wearable device ensemble of sensor modules 104 provides is combined so that processor 102 extrapolates or infers more information than what is available or achievable from a single module 104. In addition, in some embodiments, processor 102 is able to determine the best source or sources of particular parameters. As people begin to wear multiple wearable devices they will also begin to have readings for multiple versions of the same parameter. In some embodiments, processor 102 determines the reading to use from multiple versions of the same measurement, and, in some cases, determines how to combine readings from multiple sensors.

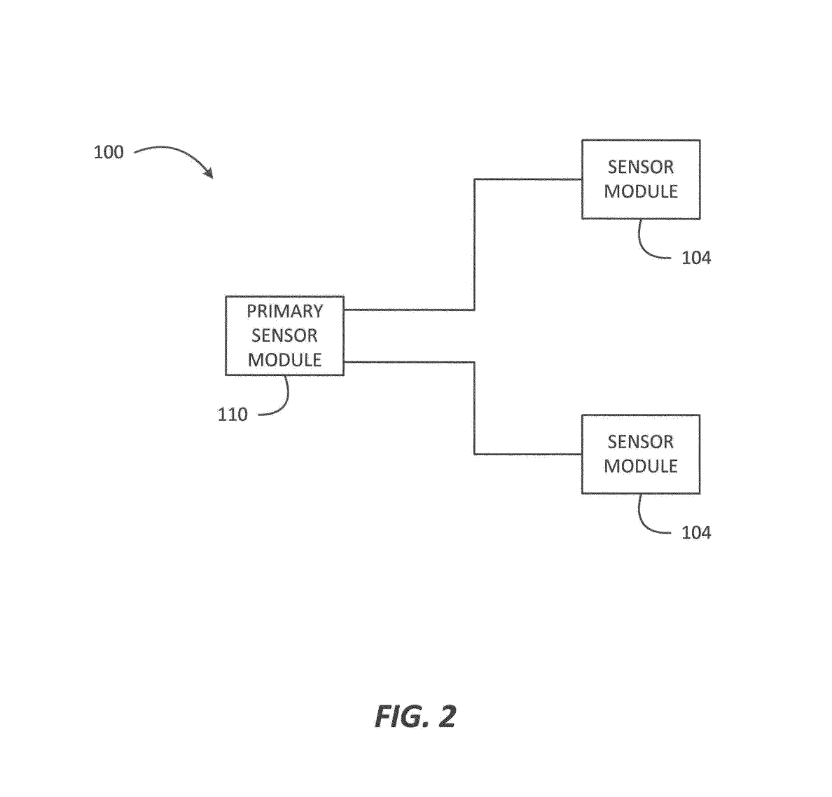

Another example embodiment of a wearable sensor prioritization system is shown in FIG. 2. In the example embodiment of FIG. 2, primary sensor module 110 is connected to one or more sensor modules 104. Primary sensor module 110 receives data from sensor modules 104 and processes the data to build a coherent picture based on the data. In some embodiments, one or more of the sensor modules 104 are wearable devices.

In an embodiment, for example, primary sensor module 110 considers the placement of a particular sensor module 104 along with the user's environment to provide an accurate picture of the user activity supported with real-time quantitative metrics (e.g., activity level, performance, calories burned). In some such embodiments, the information that the wearable device ensemble of sensor modules 104 provides is combined so that primary sensor module 110 extrapolates or infers more information than what is available or achievable from a single sensor module 104. In addition, in some embodiments, primary sensor module 110 is able to determine the best source or sources of particular parameters. As people begin to wear multiple wearable devices they will also begin to have readings for multiple versions of the same parameter. In some embodiments, processor 104 determines which measurements to rely on.

System 100 recognizes the existing relationships of sensor module to data but also takes into account the user's environment and prioritizes the sensors/devices accordingly. In some embodiments, the wearable ensemble includes sources of redundant data. In such embodiments, system 100 determines the sources that are more heavily weighted for various analyses. In some embodiments, weights are applied to the information being received from each sensor module 104 in order to determine true performance and that information is displayed according to the contextual situation of the wearer. In other embodiments, weights are applied in each sensor module 104 before the weighted data is transmitted to the inference engine.

Monitoring physical activity via a device attached at a particular limb can offer useful information but, by combining together data from multiple wearable devices, monitoring can deliver much more meaningful information on physical activity performance. To drive the point home, waving your arm with a wrist based device might lead your device to assume you are really working, while tapping your foot with your shoe alone can give the indication that you're having an intense work out. In an embodiment, the combination of both devices is used to give a much more accurate measurement and description of the activity the wearer is undertaking.

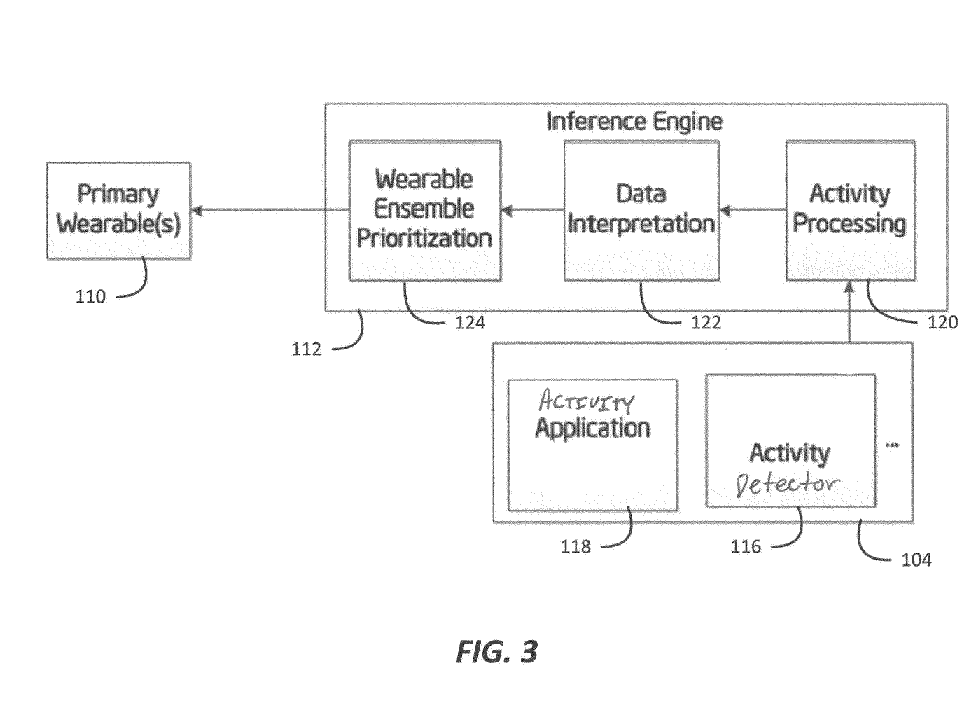

An example multiple wearable activity monitoring architecture that can be used with system 100 in FIG. 2 is shown in FIG. 3. A similar architecture can be used with system 100 of FIG. 1, with processor 102 replacing module 110 in FIG. 3.

In the example embodiment of FIG. 3, primary wearable sensor module 110 is connected to an inference engine 112. Inference engine 112 is connected in turn to sensor modules 104 and receives activity data from sensor modules 104.

In an example embodiment, each sensor module 104 is an activity detection module that includes an activity detector 116 and an activity application 118. In one such embodiment, activity application 118 receives activity context data from inference engine 112 and attempts to place the activity data being generated by activity detector 116 in context. For instance, readings for different sensor modules 104 can be used to determine whether someone is running or bicycling.

In an example embodiment, inference engine 112 includes an activity processing module 120, a data interpretation module 122 and a wearable ensemble prioritization module 124. In some embodiments, data from inference engine 112 is fed back into one or more sensor modules 104 in order to modify their operation. For instance, if inference engine determines that an athlete is bicycling, it can reduce activity in sensors geared to running or weight lifting.

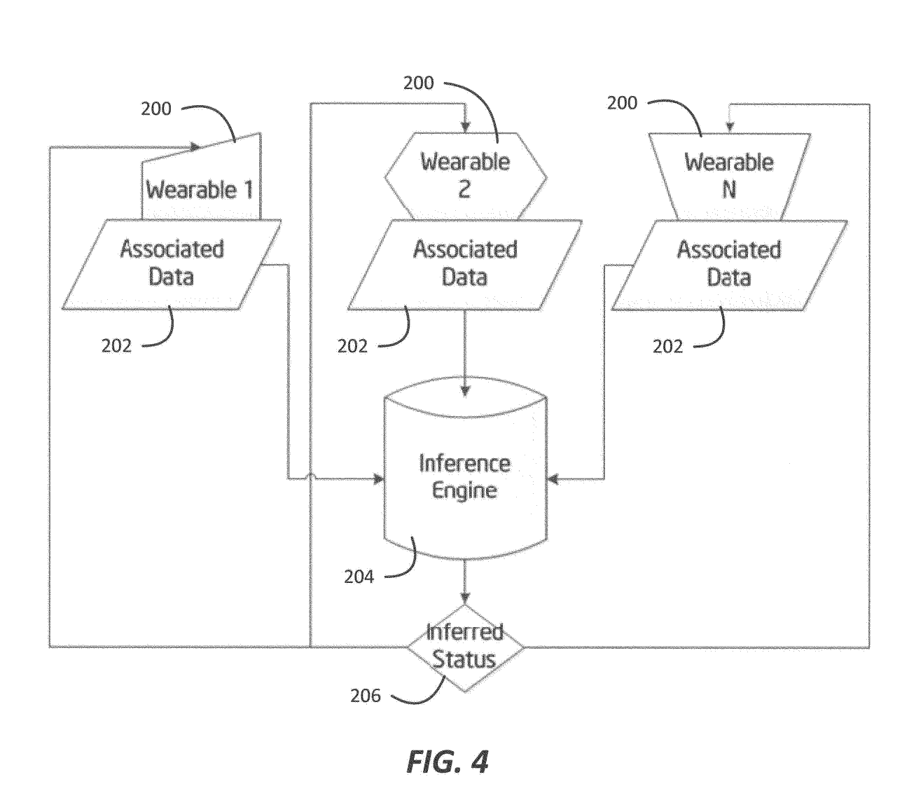

FIG. 4 illustrates process flow in a wearable sensor prioritization system such as system 100. In the process flow of FIG. 4, each wearable sensor 104 performs its activity detection and measurement activity at 200 and, at 202, forwards data representative of that activity detection and measurement activity to inference engine 112. At 204, inference engine 112 determines context from the received data and provides an inferred status at 206 to each of the wearable sensors 104. One or more of the wearable sensors 104 use the inferred status to provide a context to their data measurements. Others use the inferred status to update their algorithms or the processing performed on their data measurements.

In an embodiment, inference engine 112 is distributed across two or more sensor modules 104.

In some embodiments, wearable sensor modules 104 such as watches, jewelry, shoes, and head mounted displays operate together to provide an accurate picture of the wearer's activity and performance. In some such embodiments, sensor modules 104 are activity aware and capable of real-time monitoring of the user's activity.

In some embodiments, a designated primary wearable device 110 or a processor 102 receives the inferred data and provides information such as distribution of weight, force generated, maximum sprint speed, activity awareness. In some such embodiments, system 100 is able to correlate the information based upon the sensor/wearable device location on the wearer so as to provide an accurate overall picture of performance. Primary wearable device 110 or processor 102 then updates or notifies the other wearable sensor modules 104 in the ensemble of current status to so each can update their data processing accordingly. By using the sensors/devices available to the wearer, prioritization based on the following factors can aid in calculating true performance:

1) Sensor details—One sensor may not show as much detail as the other(s);

2) Power levels and consumption—One device/sensor may consume more power than necessary for a particular function or one may not have a enough power to complete a task when needed;

3) Network conditions—Timing of the information. Which device has the most recent data? Is one device/sensor experiencing more latency delay than another?

In an embodiment, parameter data representing activity measured by sensor module 104 is transferred from the sensor module 104 to inference engine 112 and context data is returned to one or more of the sensor modules 104.

In an embodiment, parameter data from two or more sensor modules 104 is combined by inference engine 112 into combined parameter data. In some embodiments, the combined parameter data is used to determine configuration data used to change the operation of one or more sensor modules 104. In some embodiments, the configuration data from the inference engine is used to tune a heuristic within the wearable sensor module. In some embodiments, the configuration data from the inference engine is used to tune a data processing algorithm within the wearable sensor module 104.

In an embodiment, the wearable sensor devices 104 and 110 worn on the different parts of the body monitor user movement on those limbs and classify this information using various heuristics to estimates performance (e.g., calories burned or metabolic equivalents (METs)) and the primary wearable 110 (or processor 102) correlates this information, providing automated performance monitoring. Individually, each wearable 104, 110 is capable of providing performance information which the wearer could evaluate and attempt to analyze on its own as they would today. However, activity-aware wearable devices such as sensor modules 104 and 110 are designed so that, when combined, the multiple wearable sensor modules 104 interact to provide an enhanced user experience that is missing from the wearable devices available today.

For instance, a shoe and wrist wearable combination provides a lot more metrics for a biker. That is, activity, maneuvering, and performance of the bike relative to time are all parameters that can be measured and evaluated. In addition, in an embodiment, wrist-based wearables are used to interpret hand-based turn signals and to activate the bike's LED indicators (or, even, LEDs embedded in the back of the biker's shirt). More examples of how combining different sensor data from multiple wearable devices can yield more intelligent and complete measurements are provided below.

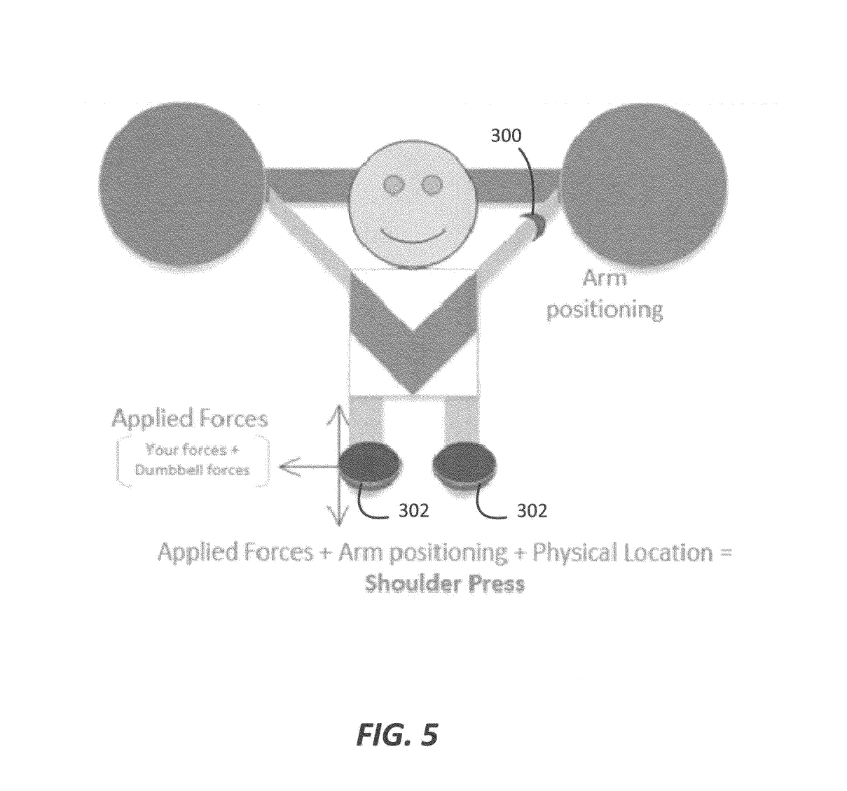

In FIG. 5, the user is wearing a wrist band 300 and a shoe-based sensor 302. Wrist band 300 provides an accelerometer for determining arm positioning while shoe-based sensor 302 provides a force sensor for determining vertical and horizontal forces on the shoe and a sensor for determining physical location. The power level in both devices is high. In this example, shoe-based sensor 302 includes a high latency network interface and is subject to infrequent polling. On the other hand, wrist band 300 includes a low latency network interface and is subject to frequent polling. As the user lifts the dumbbell, wrist band 300 determines the number of repetitions made and its sensor data takes priority due to the frequent polling for data. The information provided from the shoes is received less frequently and is therefore weighted lower in the overall calculation of physical exertion/performance (calories burned). However the physical location information aids in determining that the user is located in a gym and helps classify the activity as weight lifting.

Wrist band 300, therefore, becomes the primary sensor and is used to display time elapsed and the number of repetitions, either on band 300, or on a computing device such as a smart phone or computer. It also knows the context of the workout and provides information such as the next exercise set, etc.

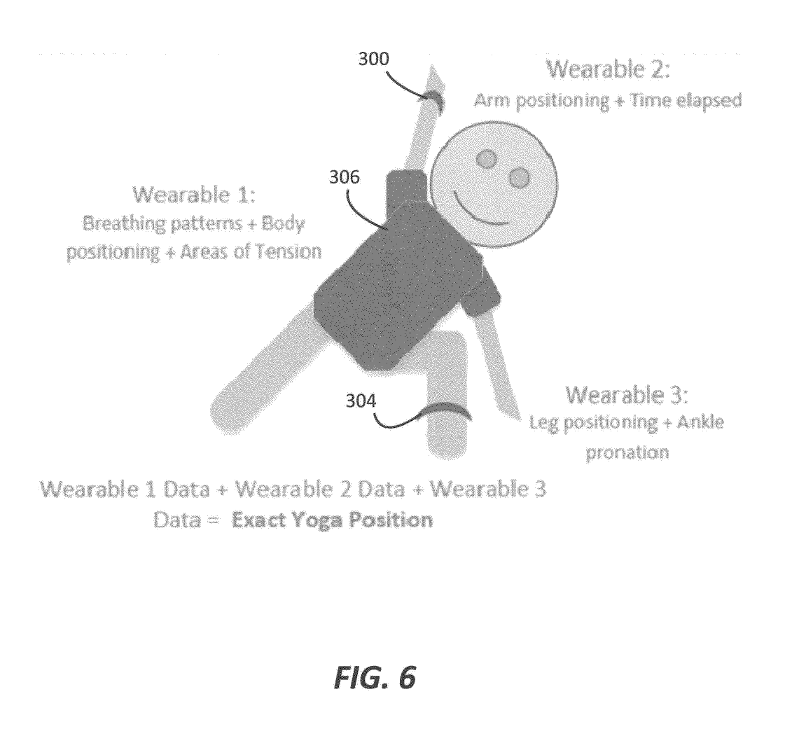

In FIG. 6, the user is wearing a wrist band 300, an ankle band 304 and a body suit 306. In this example, wrist band 300 provides an accelerometer for determining arm positioning and rate of change. Ankle band 304 provides an accelerometer for determining leg positioning and ankle pronation. In this example, body suit 306 measures temperature, breathing patterns (O₂ levels), exertion, body positioning and areas of tension. In this example, the power level in ankle band 304 and body suit 306 are at mid-level, while the power level of the wrist band is high. In this example, body suit 306 includes a low latency network interface and is subject to infrequent polling while bands 300 and 304 include a low latency network interface and are subject to frequent polling.

As the user contorts into the proper yoga positions body suit 306 is able to monitor the user's breathing patterns, body position and areas of tension. This information combined with data from wrist band 300 and ankle band 304 helps determine if the user is in the proper form and breathing properly. Ankle band 304, in concert with body suit 306, act as the primary wearable devices providing the most pertinent information used in calculating overall performance.

In an example embodiment, therefore, ankle band 300 becomes the primary sensor and is used to display time elapsed, proper form, proper breathing, etc., either on band 304, or on a computing device such as a smart phone or computer. It also knows the context of the workout and provides information such as the next yoga position, etc.

In an embodiment, inference engine 112 monitors power levels across arm band 300, ankle band 304 and body suit 306. As the power level of ankle band 304 begins to drop, inference engine 112 moves the primary sensor functionality to another device (e.g., body suit 306) to conserve energy in ankle band 304.

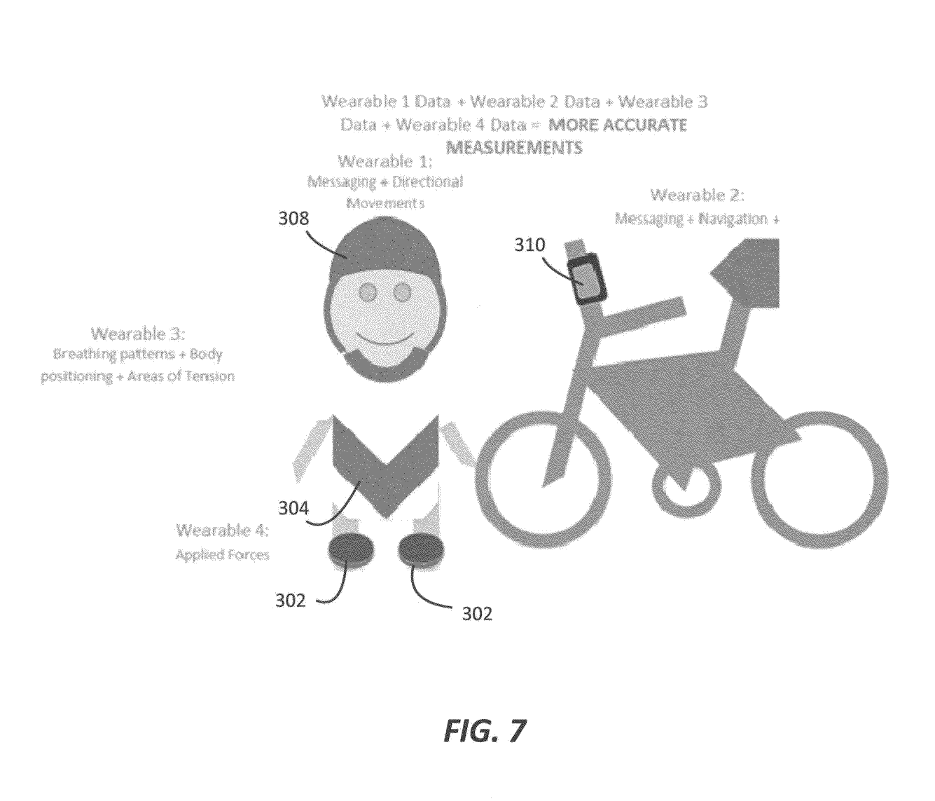

In FIG. 7, the user is wearing a shoe-based sensor 302, a body suit 306, and a helmet 308, and is carrying a smart phone 310. In this example, sensor 302 provides a force sensor for determining vertical and horizontal forces on the shoe and a sensor for determining physical location. Body suit 306 measures temperature, breathing patterns (O₂ levels), exertion, body positioning and areas of tension. In this example, helmet 308 includes sensors for detecting directional movements and for monitoring precipitation, and has the ability to message cell phone 310. Cell phone 310 includes a messaging application, a navigation application and can detect acceleration and altitude.

In this example, the power level in body suit 306 is at mid-level, the power level in helmet 308 and cellphone 310 is at high level and the power level of the shoe-based sensor 302 is at a low level. In this example, body suit 306 includes a low latency network interface and is subject to infrequent polling while shoe-based sensor 302, helmet 308 and smart phone 310 include high latency network interfaces. Helmet 308 and cell phone 310 are subject to frequent polling, while shoe-based sensor 302 is subject to less frequent polling.

As the user bikes around town the helmet 308 and cellphone 310 communicate to provide navigational directions. Body suit 306 monitors the user's breathing patterns while shoes 302 detect forces applied to the pedals and also tracks the user's physical location. The helmet 308 acts as the primary mode of message delivery to avoid distracting the bicyclist. In one example embodiment, helmet 308 includes a microphone, allowing for voice commands to be sent to determine elapsed travel time, hydration levels and performance in relationship to predefined thresholds and to send messages. In some such embodiments, the helmet also receives audio alerts and messages from the cellphone 310.

In an embodiment, inference engine 112 determines that the forces and physical location information being provided by the shoes 302 is not really necessary and, therefore, can be omitted by inference engine 112 in determining the user's physical activity and performance. In some such embodiments, either inference engine 112 or primary wearable module 110 place shoes 302 in a lower power state in such a situation to conserve power.

In one example embodiment, therefore, helmet 308 becomes the primary sensor and is used to display time elapsed, directions, speed, etc., either on a display in helmet 308, or on a computing device such as a computer or smart phone 310. In some embodiments, it also knows the context of the workout and provides information such as the rest stop, or the location of a hydration station.

In an embodiment, inference engine 112 monitors power levels across shoe-based sensor 302, body suit 306, helmet 308, and smart phone 310. In one such embodiment, as the power level of helmet 308 begins to drop, inference engine 112 moves the primary sensor functionality to another device (e.g., cell phone 310) to conserve energy in helmet 308.

In some embodiments, particular sensing functions are moved to less desirable sensors in order to preserve the capabilities of higher-value sensors when those sensors have less power.

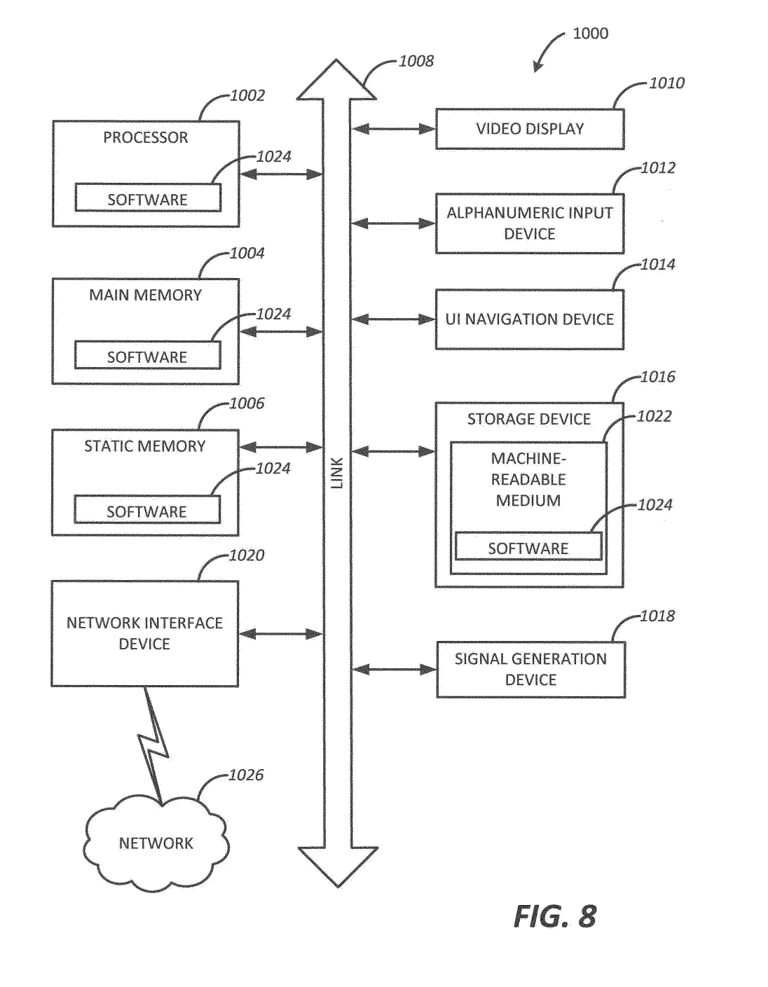

FIG. 8 is a block diagram illustrating a machine in the example form of a computer system 1000, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1000 includes at least one processor 1002 (e.g., a central processing unit (CPU), a graphics processing unit (GPU) or both, processor cores, compute nodes, etc.), a main memory 1004 and a static memory 1006, which communicate with each other via a link 1008 (e.g., bus). The computer system 102 may further include a video display unit 1010, an alphanumeric input device 1012 (e.g., a keyboard), and a user interface (UI) navigation device 1014 (e.g., a mouse). In an embodiment, the video display unit 1010, input device 1012 and UI navigation device 1014 are incorporated into a touch screen display. The computer system 102 may additionally include a storage device 1016 (e.g., a drive unit), a signal generation device 1018 (e.g., a speaker), a network interface device 1020, and one or more sensors (not shown), such as a global positioning system (GPS) sensor, compass, accelerometer, or other sensor.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004, static memory 1006, and/or within the processor 1002 during execution thereof by the computer system 102, with the main memory 1004, static memory 1006, and the processor 1002 also constituting machine-readable media.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples:

Example 1 includes subject matter (such as a device, apparatus, or machine) for rationalizing data from two or more wearable sensor devices. A device detects two or more wearable sensor modules and determines, from operation parameters associated with operation of the detected wearable sensor modules, a first sensor module. The device combines parameter data measured by two or more of the sensor modules, wherein combining includes reviewing the operation parameters of the wearable sensor modules supplying the parameter data to be combined, and distributes the parameter data under the control of the first sensor module.

In Example 2, the subject matter of Example 1 may optionally include combining parameter data measured by two or more of the sensor modules further includes forwarding the parameter data to be combined to an inference engine, and returning context data to one or more of the wearable sensor modules.

In Example 3, the subject matter of Example 1 may optionally include combining parameter data measured by two or more of the sensor modules further includes forwarding the parameter data to be combined to an inference engine, and returning configuration data from the inference engine to one or more of the wearable sensor modules.

In Example 4, the subject matter of Example 3 may optionally include returning configuration data from the inference engine to one or more of the wearable sensor modules includes returning information used to tune a heuristic within the wearable sensor module.

In Example 5, the subject matter of Example 3 may optionally include returning configuration data from the inference engine to one or more of the wearable sensor modules includes returning information used to tune a data processing algorithm within the wearable sensor module.

In Example 6, the subject matter of Example 1 may optionally include combining parameter data measured by two or more of the sensor modules further includes weighting parameter data received from each wearable sensor module as a function of the operating parameters of that module.

In Example 7, the subject matter of Example 1 may optionally include combining parameter data measured by two or more of the sensor modules further includes selecting, via the first sensor module, the parameter data to be displayed.

In Example 8, the subject matter of Example 1 may optionally include distributing the parameter data under the control of the first sensor module includes displaying the parameter data as commanded by the first sensor module.

Example 9 includes a system, method or apparatus for prioritizing data received from wearable sensor modules in a sensor system having a plurality of wearable sensor modules. Operation parameters associated with operation of the wearable sensor modules are used to determine a first sensor module. Parameter data measured by two or more of the wearable sensor modules is combined, wherein combining includes reviewing the operation parameters of the wearable sensor modules supplying the parameter data to be combined and combining the data as a function of the reviewed operation parameters. The combined parameter data is distributed under the control of the first sensor module.

In Example 10, the subject matter of Example 9 may optionally include that combining parameter data measured by two or more of the wearable sensor modules further includes forwarding the parameter data to be combined to an inference engine, and returning context data from the inference engine to one or more of the wearable sensor modules.

In Example 11, the subject matter of Example 9 may optionally include that combining parameter data measured by two or more of the wearable sensor modules further includes forwarding the parameter data to be combined to an inference engine, and returning configuration data from the inference engine to one or more of the wearable sensor modules.

In Example 12, the subject matter of Example 9 may optionally include that returning configuration data from the inference engine to one or more of the wearable sensor modules includes returning information used to tune a heuristic within the wearable sensor module.

In Example 13, the subject matter of Example 9 may optionally include that returning configuration data from the inference engine to one or more of the wearable sensor modules includes returning information used to tune a data processing algorithm within the wearable sensor module.

In Example 14, the subject matter of Example 9 may optionally include that combining parameter data measured by two or more of the wearable sensor modules further includes weighting parameter data received from each wearable sensor module as a function of the operating parameters of that module.

In Example 15, the subject matter of Example 9 may optionally include that combining parameter data measured by two or more of the sensor modules further includes selecting, via the first sensor module, the parameter data to be displayed.

In Example 16, the subject matter of Example 9 may optionally include that distributing the parameter data under the control of the first sensor module includes displaying the parameter data via the first sensor module.

Example 17 includes a wearable sensor module. The wearable sensor module includes a sensor and a processor connected to the sensor. The sensor is designed to measure parameter data corresponding to an activity. The processor is designed to receive parameter data from the sensor. The processor includes an inference engine interface, wherein the inference engine interface, when coupled to an inference engine, transmits the parameter data to the inference engine and receives configuration data from the inference engine. The processor is designed to use the configuration data received from the inference engine to modify the parameter data received from the sensor.

In Example 18, the subject matter of Example 17 may optionally include that the inference engine interface receives context data from the inference engine, wherein the processor is designed to modify the parameter data based on the context data.

In Example 19, the subject matter of Example 17 may optionally include that the processor is designed to use the configuration data to tune a heuristic within the wearable sensor module.

In Example 20, the subject matter of Example 17 may optionally include that the processor is designed to use the configuration data to tune a data processing algorithm within the wearable sensor module.

In Example 21, the subject matter of Example 17 may optionally include that the processor is designed to weight parameter data received from the sensor as a function of operating parameters for the module.

Example 22 includes a sensor system. The sensor system includes one or more networks and a plurality of wearable sensor modules connected by the one or more networks. Each wearable sensor module transmits its operating parameters to one or more other wearable sensor modules, wherein the operating parameters are used to select a first sensor module.

In Example 23, the subject matter of Example 22 may optionally include that the operating parameters are further used to prioritize data sources within the plurality of wearable sensor modules.

In Example 24, the subject matter of Example 22 may optionally include that the first sensor module is designed to place one of the other sensor modules in a low power state.

In Example 25, the subject matter of Example 22 may optionally include that the first sensor module includes an inference engine, wherein the inference engine receives activity data from two or more of the wearable sensor devices, prioritizes the activity data as a function of its source and provides data to one or more of the wearable sensor modules used to configure the wearable sensor module.

In Example 26, the subject matter of Example 25 may optionally include that the data from the inference engine is used to tune a heuristic within the wearable sensor module.

In Example 27, the subject matter of Example 25 may optionally include that the data from the inference engine is used to tune a data processing algorithm within the wearable sensor module.

In Example 28, the subject matter of Example 22 may optionally include that an inference engine is distributed across two or more sensor modules, wherein the inference engine receives activity data from two or more of the wearable sensor devices, prioritizes the activity data as a function of its source and provides data to one or more of the wearable sensor modules used to configure the wearable sensor module.

In Example 29, the subject matter of Example 16 may optionally include that the system further comprises a processor connected to one of the networks, wherein the processor receives activity data from two or more of the wearable sensor devices, prioritizes the activity data as a function of its source and provides data to one or more of the wearable sensor modules, wherein the data provided to the wearable sensor modules is used to configure the wearable sensor modules.

In Example 30, the subject matter of Example 29 may optionally include that the processor places a sensor module in a low power state when its data is not needed.

Example 31 includes a sensor system. The sensor system includes a processor, one or more networks and a plurality of wearable sensor modules connected by the one or more networks. Each wearable sensor module transmits its operating parameters to the processor, wherein the processor uses the operating parameters to prioritize data sources within the plurality of wearable sensor modules.

In Example 32, the subject matter of Example 31 may optionally include that the processor places a sensor module in a low power state when its data is not needed.

In Example 33, the subject matter of Example 31 may optionally include that the processor includes an inference engine, wherein the inference engine receives activity data from two or more of the wearable sensor devices, prioritizes the activity data as a function of its source and provides data to one or more of the wearable sensor modules, wherein the data provided by the inference engine is used to configure the wearable sensor module.

In Example 34, the subject matter of Example 33 may optionally include that the data from the inference engine is used to tune a heuristic within the wearable sensor module.

In Example 35, the subject matter of Example 33 may optionally include that the data from the inference engine is used to tune data processing within the wearable sensor module.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described.

However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example.

Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. At least one machine readable medium comprising a plurality of instructions that in response to being executed on a computing device, cause the computing device to carry out a method, the method comprising:
detecting two or more wearable sensor modules;
determining, from operation parameters associated with operation of the detected wearable sensor modules, a first sensor module;
combining parameter data measured by two or more of the sensor modules, wherein combining includes reviewing the operation parameters of the wearable sensor modules supplying the parameter data to be combined; and
distributing the parameter data under the control of the first sensor module.

2. The at least one machine readable medium of claim 1, wherein combining parameter data measured by two or more of the sensor modules further includes forwarding the parameter data to be combined to an inference engine, and returning context data to one or more of the wearable sensor modules.

3. The at least one machine readable medium of claim 1, wherein combining parameter data measured by two or more of the sensor modules further includes forwarding the parameter data to be combined to an inference engine, and returning configuration data from the inference engine to one or more of the wearable sensor modules.

4. The at least one machine readable medium of claim 3, wherein returning configuration data from the inference engine to one or more of the wearable sensor modules includes returning information used to tune a heuristic within the wearable sensor module.

5. The at least one machine readable medium of claim 3, wherein returning configuration data from the inference engine to one or more of the wearable sensor modules includes returning information used to tune a data processing algorithm within the wearable sensor module.

6. The at least one machine readable medium of claim 1, wherein combining parameter data measured by two or more of the sensor modules further includes selecting, via the first sensor module, the parameter data to be displayed.

7. The at least one machine readable medium of claim 1, wherein distributing the parameter data under the control of the first sensor module includes displaying the parameter data as commanded by the first sensor module.

8. In a sensor system having a plurality of wearable sensor modules, a method of prioritizing data received from the wearable sensor modules, comprising:
determining, from operation parameters associated with operation of the wearable sensor modules, a first sensor module;
combining parameter data measured by two or more of the wearable sensor modules, wherein combining includes reviewing the operation parameters of the wearable sensor modules supplying the parameter data to be combined and combining the data as a function of the reviewed operation parameters; and
distributing the parameter data under the control of the first sensor module.

9. The method of claim 8, wherein combining parameter data measured by two or more of the wearable sensor modules further includes forwarding the parameter data to be combined to an inference engine, and returning context data from the inference engine to one or more of the wearable sensor modules.

10. The method of claim 8, wherein combining parameter data measured by two or more of the wearable sensor modules further includes forwarding the parameter data to be combined to an inference engine, and returning configuration data from the inference engine to one or more of the wearable sensor modules.

11. The method of claim 8, wherein combining parameter data measured by two or more of the wearable sensor modules further includes weighting parameter data received from each wearable sensor module as a function of the operating parameters of that module.

12. The method of claim 8, wherein combining parameter data measured by two or more of the sensor modules further includes selecting, via the first sensor module, the parameter data to be displayed.

13. A machine readable storage medium including program code which, when executed, causes a machine to perform the method of claim 8.

14. A wearable sensor module, comprising, comprising:
a sensor, wherein the sensor is designed to measure parameter data corresponding to an activity; and
a processor connected to the sensor, wherein the processor is designed to receive parameter data from the sensor;
wherein the processor includes an inference engine interface, wherein the inference engine interface, when coupled to an inference engine, transmits the parameter data to the inference engine and receives configuration data from the inference engine;
wherein the processor is designed to use the configuration data received from the inference engine to modify the parameter data received from the sensor.

15. The module of claim 14, wherein the processor is designed to use the configuration data to tune a data processing algorithm within the wearable sensor module.

16. The module of claim 14, wherein the processor is designed to weight parameter data received from the sensor as a function of operating parameters for the module.

17. A sensor system, comprising:
one or more networks; and
a plurality of wearable sensor modules connected by the one or more networks;
wherein each wearable sensor module transmits its operating parameters to one or more other wearable sensor modules, wherein the operating parameters are used to select a first sensor module.

18. The sensor system of claim 17, wherein the operating parameters are further used to prioritize data sources within the plurality of wearable sensor modules.

19. The sensor system of claim 17, wherein the first sensor is designed to place one of the other sensor modules in a low power state.

20. The sensor system of claim 17, wherein the first sensor module includes an inference engine, wherein the inference engine receives activity data from two or more of the wearable sensor devices, prioritizes the activity data as a function of its source and provides data to one or more of the wearable sensor modules used to configure the wearable sensor module.

21. The sensor system of claim 20, wherein the data from the inference engine is used to tune a heuristic within the wearable sensor module.

22. The sensor system of claim 20, wherein the data from the inference engine is used to tune a data processing algorithm within the wearable sensor module.

23. The sensor system of claim 17, wherein an inference engine is distributed across two or more sensor modules, wherein the inference engine receives activity data from two or more of the wearable sensor devices, prioritizes the activity data as a function of its source and provides data to one or more of the wearable sensor modules used to configure the wearable sensor module.

24. The sensor system of claim 17, wherein the system further comprises a processor connected to one of the networks, wherein the processor receives activity data from two or more of the wearable sensor devices, prioritizes the activity data as a function of its source and provides data to one or more of the wearable sensor modules, wherein the data provided to the wearable sensor modules is used to configure the wearable sensor modules.

25. The sensor system of claim 24, wherein the processor places a sensor module in a low power state when its data is not needed.
